(19) United States
(12) Patent Application Publication
(10) Pub. No.: US 2024/0250288 A1
(43) Pub. Date: Jul. 25, 2024

(54) COMPOSITE SOLID-STATE ELECTROLYTE AND LITHIUM BATTERIES USING THE SAME

(71) Applicant: NATRION INC., ALBANY, NY (US)

(72) Inventors: ALEXANDER KOSYAKOV, Champaign, IL (US); SOHEIL MALEKPOUR, Champaign, IL (US); DIPOBRATO SARBAPALLI, Brunswick, OH (US); DAH-SHYANG TSAI, Champaign, IL (US); DUKE PO-CHEN SHIH, Mankato, MN (US); DILLON GRANT, Champaign, IL (US); GAVIN DEPEW, Champaign, IL (US); BRUCE KRAAY, Apex, NC (US)

(21) Appl. No.: 18/494,069

(22) Filed: Oct. 25, 2023

Related U.S. Application Data
(63) Continuation-in-part of application No. 18/492,229, filed on Oct. 23, 2023.
(60) Provisional application No. 63/380,889, filed on Oct. 25, 2022.

(51) Int. Cl. H01M 10/056; H01M 4/66; H01M 10/42

(52) U.S. Cl. CPC H01M 10/056; H01M 4/661; H01M 10/4235; H01M 2300/0071; H01M 2300/0082; H01M 2300/0094

(57) ABSTRACT

The disclosure relates to a composite solid electrolyte (CSE) for a battery in various formats including a freestanding CSE separator, electrode-CSE laminate, current collector-CSE laminate, or CSE-based mixed ionic-electronic conductor (MIEC) electrode. The disclosure also relates to the methods of making composite solid electrolytes and batteries therewith. A CSE is disclosed having at least one polymer; at least one lithium salt; a solvent plasticizer; at least one inorganic additive particle; a substrate; and one or more liquid or solid additives. A method of making a CSE is disclosed as providing, as a liquid slurry, at least one polymer, at least one lithium salt, a solvent plasticizer, at least one inorganic additive particle, and one or more liquid or solid additives and coating a substrate with the liquid slurry.

### CROSS-REFERENCE TO RELATED APPLICATIONS

This patent application claims priority to U.S. Provisional Patent Application 63/380,889 filed on Oct. 25, 2022 and U.S. patent application Ser. No. 18,492,229 filed on Oct. 23, 2023, the entireties of which are hereby incorporated herein by reference.

### GOVERNMENT ASSISTANCE

In accordance with 35 U.S.C. § 202(c)(6), Applicant hereby states that the invention disclosed in this specification was made with United States of America Federal Government support (the Department of Defense, contract number N6893622C00180) and the United States of America Federal Government has certain rights in the invention.

### TECHNICAL FIELD

The present disclosure is directed to improved battery structures. Specifically, the disclosure is related to lithium rechargeable batteries assembled using a hybrid solid-state electrolyte that is composed of a combination of one or more polymers, lithium salts, non-lithium salts, solvent plasticizers, active inorganic additives, inactive inorganic additives, and reinforcement phases. The hybrid solid-state electrolyte may be used as a freestanding separator film inside of cells or directly laminated with battery electrodes.

### BACKGROUND

Current state-of-the-art rechargeable Li-ion battery (LIB) cells employed in consumer electronics, electric vehicles (EVs), and numerous other applications are comprised of three primary components: i.) a positive electrode (cathode) that is the original source of lithium and charge within a cell, ii.) a negative electrode (anode) where lithium is temporarily stored when a cell is in a charged state, and iii.) an electrolyte that sits in the middle of a cell and facilitates the transfer of lithium between the electrodes.

Since their conception about 30 years ago, LIBs have seen the most innovation take place in their cathode materials. Until recently, LIB cathodes were the primary bottleneck with regards to cell cycle life (that is, the number of charge/discharge cycles a cell can deliver), charging speed, and energy density (that is, the amount of energy stored by a cell per unit of volume or mass). However, significant advances in cathode development have helped reverse these trends. Most LIBs are now built with either high-nickel layered-oxide cathodes like LiNi_{0.8} Mn_{0.1}Co_{0.1}O₂ (NMC811), which deliver excellent charging speeds and energy densities, or olivine-type electrodes based on LiFePO₄ (LFP), which possess less impressive power and energy capability but extremely high stability and cycle life.

The attention of academic and industrial development has now shifted to address new roadblocks to LIB capability originating from the anode and the electrolyte. For most of their history, LIBs have utilized graphite-based anodes. Li⁺ intercalates into graphite and occupies free space that exists in between the layers of one-dimensional graphene that comprises graphite. Graphite anodes have been a technological mainstay for many reasons, but their main advantage is the efficiency with which Li⁺ can be intercalated and de-intercalated into graphite. When paired with the right electrolyte, lithium can be shuttled in and out of graphite with virtually no loss. This type of efficiency of the reversibility of the intercalation process is referred to as coulombic efficiency (CE) and is why state-of-the-art LIBs can, under the right conditions, achieve thousands of charge/discharge cycles of cycle life with minimal capacity degradation.

The new challenge with graphite anodes, however, is their limited specific capacity of ˜370 milliamp-hours (mAh) per gram. This is imposed by the fact that six carbon atoms within the graphite structure must be allocated for the storage of each Li⁺ ion. The use of novel materials is required if any improvement is to be seen on the anode side that would contribute to enhanced overall LIB cell energy density. Intercalation also stands in the way of increasing the speeds at which LIBs can charge as it is an intrinsically thermodynamically slow, surface-limited process.

Liquid electrolytes, meanwhile, are the source of current LIBs' fire safety risks. LIBs are produced by sandwiching a porous separator membrane between the anode and cathode. The separator is typically made from a blend of polypropylene (PP) or polyethylene (PE), and its primary purpose is to keep the electrodes from touching. The cathode and anode are also porous, and the pore network of the cathode/separator/anode stack is subsequently infiltrated with liquid electrolyte. Liquid electrolytes are typically a solution of Lithium hexafluorophosphate (LiPF₆) or other types of lithium salt in a mixture of carbonate solvents like ethylene carbonate (EC) and diethyl carbonate (DEC). The potential safety issues of such systems are obvious, as carbonates are volatile and highly flammable—liquid electrolytes possess a flash point of ˜0° C., above which their vapors form a combustible mix with air. In a thermal runaway event, heating of an LIB cell can initiate rapid conversion of the electrolyte into gas products coupled with melting of the separator. Eventually, even the cathode and anode become fuel sources that drive ever-increasing self-heating of the cell and certain fire and/or explosion.

Manufacturers of LIBs have made significant progress towards mitigating external and internal short circuits with improved quality control and cell design which reduces the likelihood of a thermal runaway being started. However, few improvements have been made to ameliorate the severity of the fire and heat release of a thermal runway if one does occur. Moreover, studies of electrification of the automotive industry have found that EVs are less likely to catch fire than internal combustion engine (ICE) vehicles, but the consequences of an EV fire are significantly more dangerous for its passengers.

Overall, mass-market consumer sentiment demands that EVs improve in terms of five key criteria that all depend on the battery cells with which they are manufactured: i.) affordability (the battery pack is ˜75% of the total cost of an EV), ii.) charging speed, iii.) driving range on a single charge (a function of battery energy density), iv.) lifespan, and v.) safety. The technological need has led many in the industry to seek to commercialize solid-state batteries (SSBs). SSBs are broadly analogous to conventional LIBs but reduce or eliminate the use of liquid electrolyte via substitution with solid-state electrolyte (SSE) materials. The goal behind using SSEs is to reduce the combustibility of the materials comprising a cell and to enable the use of next-generation anode materials that boost cell energy density and charging speed.

SSEs generally fall under two classifications: inorganic SSEs (ceramics) and organic SSEs (polymers). Inorganic SSEs include oxidic materials such as lithium-lanthanum-zirconate (LLZO) and sulfidic materials like argyrodites. In these SSEs, defects in the ceramic crystal lattice facilitate lithium-ion transport wherein Li⁺ “hops” from defect site to defect site across the material. Organic SSEs are synthesized by dissolving lithium salts in polymer systems such as polyethylene glycol (PEG); ion transport is subsequently mediated by Arrhenius-dependent motion of polymer chain segments above the glass-transition temperature of the polymer. Such segmental chain motion continuously disassociates and associates Li⁺ with anions to move it across the material.

Both organic and inorganic SSEs tend to be significantly more electrochemically and thermally resilient than liquid electrolytes and can be utilized to construct cells that remain benign even when short-circuited or subjected to other forms of abuse. Inorganic SSEs tend to provide more wide-ranging safety improvement in this regard. Inorganic SSEs also possess distinctly higher ionic conductivity—usually at least an order of magnitude higher than organic SSEs. This ion transport performance discrepancy is made more severe by the fact that only a fraction of the ion transference in an organic SSE constitutes Li⁺ due to simultaneous mobility of the anions of the lithium salt in the polymer; in an inorganic SSE, meanwhile, all the ion transference that takes place is Li⁺. Moreover, the combination of higher ionic conductivity and Li⁺ transference in inorganic electrolytes facilitates high flux densities that can pave the way to ultra-fast charging whereas organic SSEs lack such capability and will underperform state-of-the-art liquid electrolytes.

However, inorganic SSEs have seen limited commercial success so far as a result of their poor manufacturability. LLZO, for example, is produced using common ceramic calcination and sintering processes at high temperatures (>1200° C.). The process is energy and resource intensive—due to lithium evaporation at such elevated temperatures, additional lithium must be constantly introduced into LLZO furnaces.

LLZO must often be made with multiple heat treatment/annealing steps to stabilize the material's crystallinity and grain boundary interfaces and minimize its susceptibility to cracking. Even so, LLZO and related inorganic SSE materials suffer from unfavorable mechanical properties such as limited flexibility and high brittleness. To replace polyolefin separator in an LIB cell construction, a continuous inorganic SSE phase must be produced and stacked between the anode and cathode. Ceramic SSEs' propensity to crack means that they must be made thicker (50 μm-70 μm) than regular separators (8 μm-25 μm). This compromises energy density and nullifies the extents to which charging speed can be improved as ionic conductance is dependent on material thickness.

Another major issue plaguing inorganic SSEs is the high resistance of their surfaces. While ion transport in the bulk of an inorganic SSE may be rapid, this is not the case at its interfaces. It is especially difficult to establish sufficient contact between an SSE separator and electrodes. Indeed, most commercial examples of inorganic SSE-using batteries have resorted to retaining liquid electrolyte within the porosity of their anodes and cathodes so that it may “grease” the interfaces with the SSE.

Recently, sulfidic SSEs have garnered academic and industrial attention. Sulfides are mechanically softer and more conformal at the electrode interfaces than LLZO. Sulfidic SSEs, however, possess their own manufacturing and handling challenges. They are unstable in air and made using toxic hydrogen sulfide gas.

Another drawback of sulfide is its instability against Li-metal anode (LMA). LMA is used in Li-metal batteries (LMBs), which have the potential to deliver greatly improved energy density performance characteristics as compared to state-of-the-art LIBs as LMA has a theoretical specific capacity of over 3000 mAh g⁻¹. LMBs have seen limited successful commercial introduction, though, because of the high reactivity of metallic lithium. Liquid electrolytes are rapidly reduced by LMA into inactive solid electrolyte interphase (SEI) products, resulting in poor cyclability. SSEs, with their enhanced electrochemical stability, are often considered to be an enabling technology for LMBs. However, sulfidic SSEs are plagued with a similar interaction with LMA as liquid electrolyte.

“Hybrid” or “composite” electrolytes that blend ceramic and polymer SSE phases are viewed as a way to combine the ion transport performance of the former with the favorable mechanical traits, processability, and electrochemical stability of the latter. A well-described hybrid system is LLZO-in-polyethylene oxide (PEO) or polyethylene glycol (PEG). In such a system, LLZO particles are dispersed in a lithium salt-containing PEO/PEG continuous matrix. Ion transport occurs in both phases, though there are synergistic effects. For instance, the presence of LLZO lowers the glass-transition temperature of the surrounding PEO/PEG matrix and provides mechanical reinforcement. Still, the ion transport capability of such a system can be generally described as a volume fraction average of the phases: a larger proportion of polymer to ceramic will mean more ion movement through organic phase and lower overall ionic conductivity.

### SUMMARY

The following is a summary of this disclosure. The summary does not necessarily identify key elements nor limit the scope of the disclosure, but merely serves as an introduction to the following description.

The present disclosure provides lithium rechargeable batteries that integrate a novel composite solid electrolyte (CSE).

The CSE is comprised of one or multiple polymers, lithium salts, solvent plasticizers, active (intrinsically Li-ion conductive) inorganic additive particles, inactive (not intrinsically Li-ion conductive) inorganic additive particles, continuous or discontinuous reinforcement phases, and other liquid or solid additives.

The addition of solvent plasticizers allows the CSE to be processed in a liquid slurry form. The slurry may be applied as a coating to substrates through various methods including but not limited to slot-die coating, spray coating, immersion coating, blade coating, etc.

The substrate to which the CSE slurry is applied may be a reinforcement phase such as a porous continuous webbing. This porous continuous webbing may be a conventional commercial LIB PE, PP, or PE/PP separator or another suitable continuous webbing. The plasticizer may be fully or partially removed from the slurry to solidify the CSE phase on and within the webbing to produce freestanding CSE separator film. This film may be densified using methods such calendering. A CSE slurry of one composition may be used on one side of the webbing while a slurry of a different composition may be used on the other side of the webbing, with the compositions optimized for the electrodes that each side of the separator will face.

The substrate to which the CSE slurry is applied may be a battery electrode, such as a tape composed of electrode active material, binder, and conductive additive coated onto a metal foil. The slurry may flow and infiltrate into the pore network of the electrode and/or establish a distinct coating on top of the electrode. A reinforcement webbing may be added to the distinct slurry coating on top of the electrode to support a discrete CSE separator layer. The plasticizer may be fully or partially removed from the slurry to solidify the composite solid electrolyte on and within the electrode and webbing. The electrode-CSE laminate may be densified using methods such as calendering. The electrode-CSE laminate may also be treated with a vacuum bagging technique to help facilitate thorough intrusion of CSE slurry into the electrode pore network as well as sufficient plasticizer removal.

The substrate to which the CSE slurry is applied may also be a current collector. A reinforcement webbing may be added to support the formation of a distinct CSE separator layer. The current collector may be a metal foil such as copper, aluminum, zinc, tin, nickel, magnesium, etc., or a non-metal material such as carbon textile. The current collector may be lithiophilic or lithiophilic or be coated with lithiophilic material such as zinc-oxide nanoparticles. The current collector may be two-dimensional or have a three-dimensional surface morphology or microstructure. Plasticizer may be fully or partially removed from the slurry to solidify it on the current collector. The current collector-CSE laminate may be densified using methods such as calendering.

The substrate to which the CSE slurry is applied may be a current collector with a metallic lithium coating. The metallic lithium coating may be produced through melt-infusion, vapor deposition, electrodeposition, or other methods. Electrodeposition may be accomplished in situ inside of a lithium battery cell. The substrate itself may also be a pure lithium metal foil. A reinforcement webbing may be added to support the formation of a discrete CSE separator layer. The current collector-CSE laminate may be densified using methods such as calendering.

Electrode active material particles and electronically conductive additives such as amorphous carbon particles may be added to the CSE slurry to form a mixed ionic-electronic conductor (MIEC) slurry. The MIEC slurry may be coated onto current collector materials and the plasticizer fully or partially removed to solidify the CSE matrix and produce a battery electrode. The CSE matrix serves the combined role of binder for the electrode active material and electronically conductive additive as well as Li⁺-conducting phase network for the electrode as a whole. A reinforcement webbing may be added to support the formation of a discrete CSE separator layer. The CSE-based MIEC electrode may be densified using methods such as calendering.

A densified or non-densified freestanding CSE separator, electrode-CSE laminate, current collector-CSE laminate, or CSE-based MIEC electrode may additionally have their surfaces coated with lithiophilic material such as magnesium nanoparticles or metallic lithium. This may be accomplished using vapor deposition, electrodeposition, or other methods. Electrodeposition may be accomplished in situ inside of a lithium battery cell.

Rechargeable lithium batteries may be assembled by layering freestanding CSE separator film between cathode and anode. Liquid electrolyte may be added to improve ion transport at the interfaces between the electrodes and the separator and/or if the electrodes are porous and their pore network is not accessible to the separator. A different liquid electrolyte may be used on the cathode side than on the anode side. Functional interphase stabilizers (FISs) may also be added to the surfaces of the cathode and/or anode, respectively.

Rechargeable lithium batteries may also be assembled by using electrode-CSE laminate, current collector-CSE laminate, or CSE-based MIEC electrode in the place of an electrode and electrolyte.

In one aspect, a CSE is disclosed having at least one polymer, at least one lithium salt, a solvent plasticizer, at least one inorganic additive particle, a substrate, and one or more liquid or solid additive.

In another aspect, the substrate is a continuous porous webbing selected from the group consisting of a polyethylene, polypropylene, polyolefin, a microporous film, ethylene/butene copolymer, ethylene/hexene copolymer, ethylene/methacrylate copolymer, woven fabric, woven fabric with glass fiber, woven fabric with polyethylene terephthalate fiber, cellulose, aramid fiber, another organic or synthetic fiber, or combination thereof.

In another aspect, the substrate is a battery electrode, such as conventional battery electrode or a tape composed of electrode active material, binder, and conductive additive coated onto a metal foil.

In another aspect, a reinforcement webbing is provided on the battery electrode to support a discrete CSE separator layer.

In another aspect, the substrate is a current collector having at least one of copper, aluminum, zinc, tin, nickel, magnesium, or carbon textile.

In another aspect, the current collector may be lithiophilic or lithiophilic or be coated with at least one lithiophilic material selected from the group of zinc-oxide nanoparticles and magnesium nanoparticles of metallic lithium, and wherein the current collector has a two- or three-dimensional surface morphology or microstructure.

In another aspect, the current collector is a lithium metal foil, or a foil coated with metallic lithium.

In another aspect, the CSE is configured to prohibit short-circuit of a battery by serving the function of an ionically-conductive but electronically-insulative barrier between a cathode and an anode of a battery cell.

In another aspect, the CSE mitigates dendrite growth on an anode of a battery cell and prevents dendrites from short-circuiting the battery cell by maintaining an operating rigidity which is impenetrable to dendrites.

In another aspect, a method of making a CSE is disclosed having the steps of providing, as a liquid slurry, at least one polymer, at least one lithium salt, a solvent plasticizer, at least one inorganic additive particle, and one or more liquid or solid additives and coating a substrate with the liquid slurry.

In another aspect, the coating step is performed using at least one of slot-die coating, spray coating, immersion coating, and blade coating.

In another aspect, the method further includes the step of removing the solvent plasticizer from the liquid slurry to solidify the liquid slurry phase on or within the substrate.

In another aspect, the method further includes the step of coating a second side of the substrate with a second liquid slurry, the second liquid slurry being the same or different than the first liquid slurry.

In another aspect, the slurry may infiltrate a pore network of the substrate or establish a coating on top of the substrate.

In another aspect, the substrate is a continuous porous webbing selected from the group consisting of a polypropylene separator, polyethylene separator, or a polypropylene/polyethylene separator.

In another aspect, the substrate is a battery electrode, such as conventional battery electrode or a tape composed of electrode active material, binder, and conductive additive coated onto a metal foil.

In another aspect, the method further includes the step of providing a reinforcement webbing on the battery electrode to support a discrete CSE separator layer and wherein the slurry solidifies on and within the reinforcement webbing.

In another aspect, the method further includes the step of vacuum bagging the electrode and slurry to facilitate thorough intrusion of the slurry into a pore network of the electrode and plasticizer removal.

In another aspect, the method further includes the step of mixing the slurry with electrode active material particles and electronically conductive additives such as amorphous carbon particles to produce a mixed ionic-electronic conductor (MIEC) slurry.

In another aspect, the method further includes the step of calendering or other method of densification.

In another aspect, the method further includes the steps of melt-infusion, vapor deposition, and electrodeposition.

In another aspect, a battery is disclosed having an anode, a cathode, a separator, a current collector, and a functional interphase stabilizer having an organic nonaqueous solvent and a lithium salt in solution with the organic nonaqueous solvent.

In another aspect, the nonaqueous solvent includes at least one of 1,2-Dimethoxyethane (DME), 1,1,2,2-Tetrafluoroethyl-2,2,3,3-tetrafluoropropyl ether (TTE), Dimethyl sulfide (DMS), Fluoroethylene carbonate (FEC), Vinylene carbonate, Dimethyl sulfoxide (DMSO), Dimethyl methylphosphonate (DMMPh), Trimethyl phosphate (TMP), Tris(trimethylsilyl)phosphite (TMSPi), Dioxolane (DOL), 1,1-Diethoxyethane (DEE), Tetrahydrofuran (THF), Triphenyl phosphate (TPhP), Tris(2,2,2-trifluoroethyl) orthoformate (TFEO), Vinylene carbonate (VC), Triethyl phosphate (TEP), Sulfolane (SL), Methyl 1,1,2,2 Tetrafluoroethyl ether (TFME), Methyl beta-L-fucopyranoside (MFB), 1,2-(1,1,2,2-Tetrafluoroethoxy)ethane, 1,1,2,2-Tetrafluoroethyl-1H,1H,5H-octafluoropentyl ether, or Acetonitrile.

In another aspect, the lithium salt is selected from the group consisting of at least one of Lithium bis(trifluoromethanesulfonyl)imide (LiTFSI), Lithium bis(fluoromethanesulfonyl)imide (LiFSI), Lithium fluoride (LiF), Lithium nitrate (LiNO₃), Lithium difluoro(oxalato)borate (LiDFOB), Lithium iodide (LiI), Lithium Difluorophosphate (LiPO₂F₂), or Lithium hexafluorophosphate (LiPF₆).

In another aspect, the separator is selected from the group consisting of a polymer membrane or a multilayered film of polyethylene, polypropylene, polyolefin, a microporous film, ethylene/butene copolymer, ethylene/hexene copolymer, ethylene/methacrylate copolymer, woven fabric, woven fabric with glass fiber, woven fabric with polyethylene terephthalate fiber, cellulose, aramid fiber, another organic or synthetic fiber, ceramic, composite polymer-ceramic solid-state electrolyte, or a combination thereof.

In another aspect, the cathode is selected from a group consisting of lithium-containing spinels such as LiNi_{0.5} Mn_{1.5}O₄ (LNMO), olivines such as lithium iron-phosphate (LFP), transition metal oxides of the form LiMeOₓ wherein Me is one or more metal selected from nickel (Ni), cobalt (Co), manganese (Mn) and aluminum (Al), Li and O represent one or more respective lithium and oxygen atoms, and x represents the number of oxygen atoms, or other suitable cathode active materials containing lithium or reliant upon prelithiation.

In another aspect, the anode is selected from the group consisting of a carbon-based material including artificial and natural graphite, silicon-based materials including pure silicon and silicon-oxide, silicon-carbon composites, lithium titanate, lithium vanadate, or other related lithium metal oxide anode material, lithium-metal, and lithium metal alloys.

In another aspect, the anode, the separator, the cathode are each one of an electrode-CSE laminate, current collector-CSE laminate, or CSE-based MIEC electrode.

In another aspect, the separator is a porous polyolefin separator that has been coated and/or infused with a CSE or composed of a freestanding CSE film.

In another aspect, the coating of infusion of CSE into and/or onto a cathode and/or anode may or may not produce a discrete CSE separator phase on the surface of the cathode and/or anode.

In another aspect, the current collector is coated with or infused with the CSE.

In another aspect, the current collector has a lithiophilic coating, including but not limited to metallic lithium.

In another aspect, the current collector is coated with a MIEC slurry to produce an electrode/CSE hybrid wherein the CSE serves the function of a binder phase and a Li ion-conducting phase and optionally serves the additional function of a discrete CSE separator phase on the surface of the MIEC.

In one aspect of the present teachings, a CSE is disclosed having a continuous polymer matrix, lithium salt dissolved in the polymer matrix, inactive or active inorganic phase particles dispersed in the polymer matrix, and other inorganic or organic additives added to the matrix which may or may not include mechanical reinforcement phase additives.

In another aspect of the present teachings, a rechargeable lithium battery is assembled having a separator composed of a freestanding film made from the CSE.

In another aspect of the present teachings, a rechargeable lithium battery is assembled having a conventional porous polyolefin separator that has been coated and/or infused with the CSE to produce a freestanding solid-state electrolyte film.

In another aspect of the present teachings, the CSE facilitates the mobility of lithium ions.

In another aspect of the present teachings, a rechargeable lithium battery is assembled having an anode and/or a cathode wherein the CSE is coated and/or infused on/into the anode or the cathode.

In another aspect of the present teachings, the coating or infusion of CSE into and/or onto a cathode and/or anode may or may not also produce a discrete CSE separator phase on the surface of the cathode and/or anode.

In another aspect of the present teachings, a rechargeable lithium battery is assembled having one or more current collectors coated and/or infused with the CSE.

In another aspect of the present teachings, the current collector possesses a lithiophilic coating, which may or may not be metallic lithium.

In another aspect of the present teachings, the CSE possesses a lithiophilic coating, which may or may not be metallic lithium.

In another aspect of the present teachings, the CSE contains electrode active material particles and/or electronically conductive additives to form a MIEC.

In another aspect of the present teachings, the mixed ionic electronic-conductor is coated onto a current collector to produce an electrode/CSE hybrid wherein the CSE serves the functions of a binder phase and a Li ion-conducting phase and may or may not serve the additional function of a discrete CSE separator phase on the surface of the MIEC.

In another aspect of the present teachings, a rechargeable lithium battery cell is assembled having a CSE-based MIEC cathode and/or anode.

In another aspect of the present teachings, the cathode active material is selected from a group consisting of lithium-containing spinels such as LiNi_{0.5} Mn_{1.5}O₄ (LNMO), olivines such as lithium iron-phosphate (LFP), transition metal oxides of the form LiMeOₓ wherein Me is one or more metal selected from nickel (Ni), cobalt (Co), manganese (Mn) and aluminum (Al), Li and O represent one or more respective lithium and oxygen atoms, and x represents the number of oxygen atoms, or other suitable cathode active materials containing lithium or reliant upon prelithiation.

In another aspect of the present teachings, the anode active material is selected from the group consisting of a carbon-based material including artificial and natural graphite, silicon-based materials including pure silicon and silicon-oxide, silicon-carbon composites, lithium titanate, lithium vanadate, or other related lithium metal oxide anode material, lithium-metal, and lithium metal alloys.

In another aspect of the present teachings, a rechargeable lithium battery cell wherein the CSE separator, whether a freestanding film or a layer laminated to CSE-coated electrode, CSE-coated current collector, and/or CSE-based MIEC electrode, is configured to prohibit short-circuit of the battery by serving the function of an ionically-conductive but electronically-insulative barrier between the cathode and anode of the cell.

In another aspect of the present teachings, a rechargeable lithium battery cell wherein the CSE separator, whether a freestanding film or a layer laminated to CSE-coated electrode, CSE-coated current collector, and/or CSE-based MIEC electrode, mitigates dendrite growth on the anode of the cell and prevents dendrites from short-circuiting the cell by maintaining an operating rigidity of which is impenetrable to dendrites.

In another aspect of the present teachings, a liquid functional interphase stabilizer (FIS) which forms the interphase between the CSE/separator layer and the cathode and/or anode, the liquid wetting agent having at least one organic nonaqueous solvent and at least one lithium salt in a molar concentration of about 0.1 M to about 8 M.

In another aspect of the present teachings, the FIS includes at least one of 1,2-Dimethoxyethane (DME), 1,1,2,2-Tetrafluoroethyl-2,2,3,3-tetrafluoropropyl ether (TTE), Dimethyl sulfide (DMS), Fluoroethylene carbonate (FEC), Vinylene carbonate, Dimethyl sulfoxide (DMSO), Dimethyl methylphosphonate (DMMPh), Trimethyl phosphate (TMP), Tris(trimethylsilyl)phosphite (TMSPi), Dioxolane (DOL), 1,1-Diethoxyethane (DEE), Tetrahydrofuran (THF), Triphenyl phosphate (TPhP), Tris(2,2,2-trifluoroethyl) orthoformate (TFEO), Vinylene carbonate (VC), Triethyl phosphate (TEP), Sulfolane (SL), Methyl 1,1,2,2 Tetrafluoroethyl ether (TFME), Methyl beta-L-fucopyranoside (MFB), 1,2-(1,1,2,2-Tetrafluoroethoxy)ethane, 1,1,2,2-Tetrafluoroethyl-1H,1H,5H-octafluoropentyl ether, or Acetonitrile.

In another aspect of the present teachings, the FIS includes at least one of Lithium bis(trifluoromethanesulfonyl)imide (LiTFSI), Lithium bis(fluoromethanesulfonyl)imide (LiFSI), Lithium fluoride (LiF), Lithium nitrate (LiNO₃), Lithium difluoro(oxalato)borate (LiDFOB), Lithium iodide (LiI), Lithium Difluorophosphate (LiPO₂F₂), or Lithium hexafluorophosphate (LiPF₆).

In another aspect of the present teachings, the FIS forms a solid electrolyte interphase on the anode which is mechanically adhered to the solid-state electrolyte.

In another aspect of the present teachings, the FIS forms a cathode electrolyte interphase on the cathode which is mechanically adhered to the solid-state electrolyte.

In another aspect of the present teachings, the FIS enables high coulombic efficiencies and charge/discharge cycling stability in rechargeable battery cells even at low uniaxial stack compression due to the mechanical adhesion with the CSE and low propensity for interphase cracking.

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings.

### BRIEF DESCRIPTION OF THE DRAWINGS

FIG. 1 shows a lithium ion transport mechanism in prior hybrid electrolyte systems such as lithium-lanthanum-zirconate (LLZO) in polyethylene oxide (PEO). Li⁺ mobility is faster in inorganic phase particles 1 and slower in the continuous polymeric matrix. The ion transport performance can be approximated as a volume phase fraction of the respective ionic conductivity and Li⁺ transference of the inorganic phase 11 and organic phase 12.

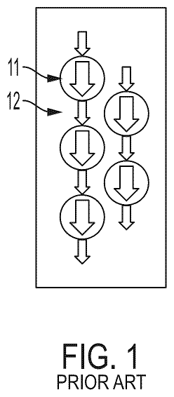

FIG. 2 shows a Lithium-ion transport mechanism in hybrid composite solid electrolyte with polyvinylidene fluoride (PVDF) polymer, Lithium bis(trifluoromethanesulfonyl)imide (LiTFSI) salt, triethyl phosphate (TEP) plasticizer, and metakaolin inorganic additive. Inorganic particle 21 is shown within the interaction volume of inorganic/organic interface 22. Continuous Li⁺ transport is shown along synergistic particle/polymer interfaces (interaction volumes). Though intrinsically not Li⁺-conductive, metakaolin associates with the LiTFSI and TEP in “interaction volumes” surrounding each metakaolin particle to form percolation networks through the electrolyte bulk in which Li⁺ is coordinated by double-bonded oxygen atoms in TEP and sulfonyl groups of the LiTFSI anion. The interaction volumes may be 27× larger than the metakaolin particles themselves. Additional contributions to the ion transport performance may come from the Lewis acid strength of metakaolin surfaces, which would further demobilize TFSI⁻ and enhance Li⁺ transference, as well as segmental chain motion of the PVDF polymer, which is augmented by the x-ray amorphousness of metakaolin.

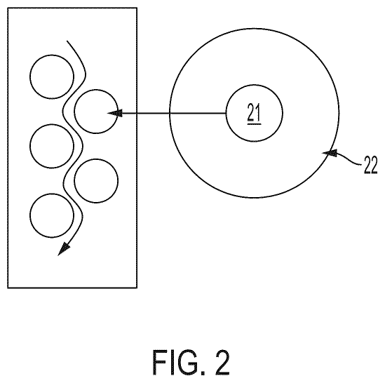

FIG. 3 shows a freestanding CSE separator film made using blade coating of CSE slurry onto commercial porous PE separator reinforcement webbing. The reinforcement webbing is 8 μm-thick and the slurry coating thickness on either side of the webbing was approximately 30 μm. Plasticizer was removed from the slurry via vacuum drying between 80° C. and 100° C. for 40 minutes. The final freestanding solid-state electrolyte separator was 16 μm thick before densification.

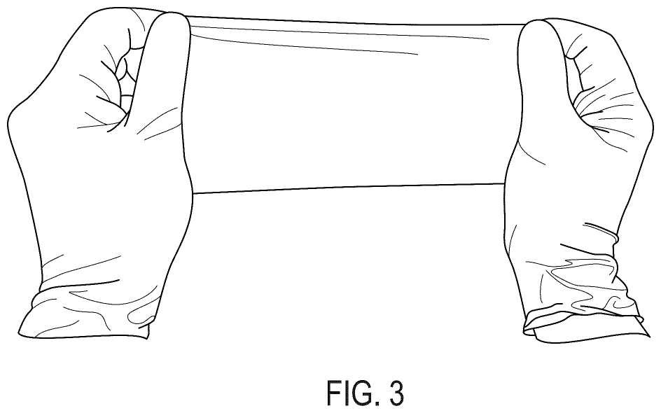

FIG. 4 shows a method and device for blade coating porous PE separator with CSE slurry. A roll of separator (top right) is unspooled through a tensioner before being threaded between the drawbar and the doctor blade, which sit atop a glass plate on the applicator bed. Slurry is dispensed in front of the doctor blade, which is pushed forward by the drawbar. Through such a method, the web is laid down on the slurry coating immediately behind the blade.

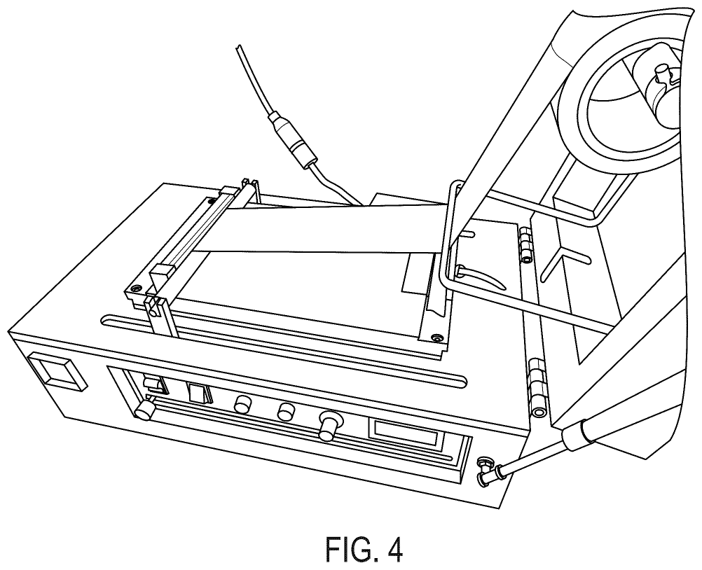

FIG. 5 shows a continuous freestanding CSE separator film made using immersion coating of CSE slurry onto commercial porous PE separator reinforcement webbing.

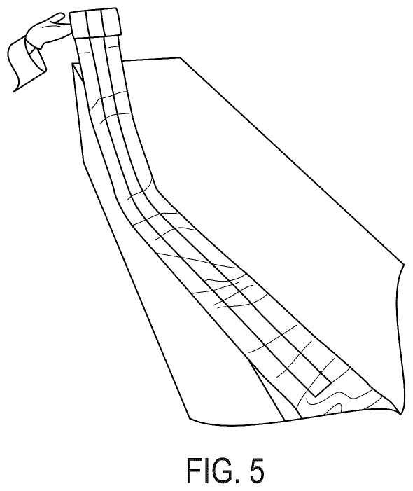

FIG. 6 shows a method and device for immersion coating of PE separator reinforcement webbing. A separator roll is unspooled and wound through tensioners before being brought into a bath of CSE slurry under a roller. Excess slurry is scraped off using blades before the CSE slurry-wetted separator is wound by the uptake roller onto aluminum foil substrate. Without an inline oven, the whole wetted separator roll may instead be placed into a vacuum oven between 80° C. and 100° C. for 12 hours to remove the plasticizer.

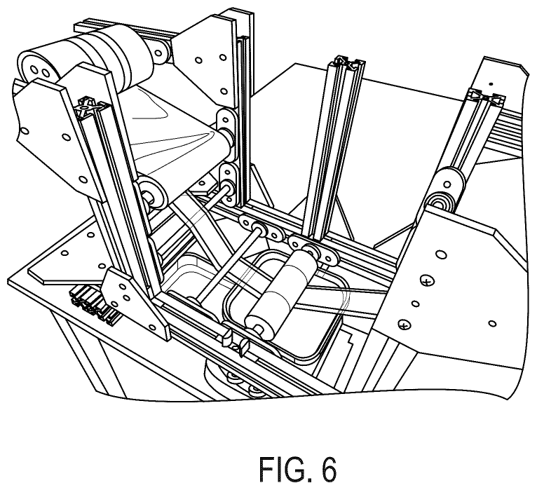

FIG. 7 shows a mass % remaining versus temperature diagram of a dynamic thermogravimetric analysis (TGA) carried out between room temperature and 500° C. at 10° C. min⁻¹ ramp rate of freestanding CSE separator films made through 30 μm blade coating of CSE slurry onto 8 μm PE webbing and drying with varying amounts of time between zero hours and 12 hours. The differing mass ratios of volatilizable constituents indicate the differing concentrations of residual plasticizer in the freestanding films. Hence, the plasticizer quantity in the product material may be tuned. The TGA also demonstrates the high thermal stability of the material overall. At 300° C., the lines are, from most mass percentage remaining to least, the 6 h, 12 h, 3 h, 1 h, 0 h.

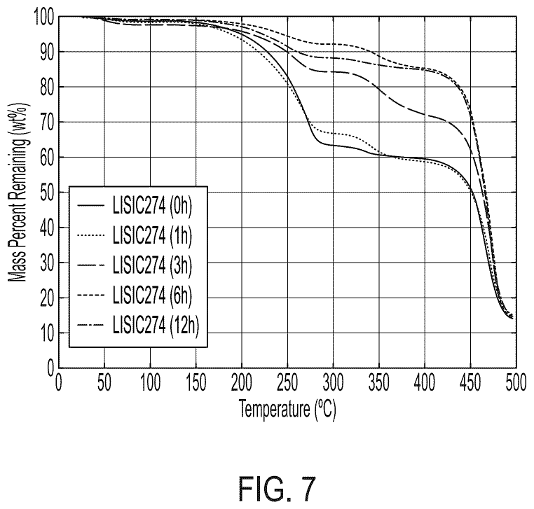

FIG. 8 shows a table describing freestanding CSE separators using different lithium salts, inorganic additives, reinforcement webbings, and additional additives. Ionic conductivity was determined by first cutting freestanding separator films into 19 mm-diameter discs. The discs were loaded into Swagelok cells with stainless steel blocking electrodes. Electrochemical impedance spectroscopy was performed at room temperature and the ionic resistivity (inverse of ionic conductivity) found using the x-intercept of a linear fit of the Nyquest plot between 100 Hz and 100 kHz.

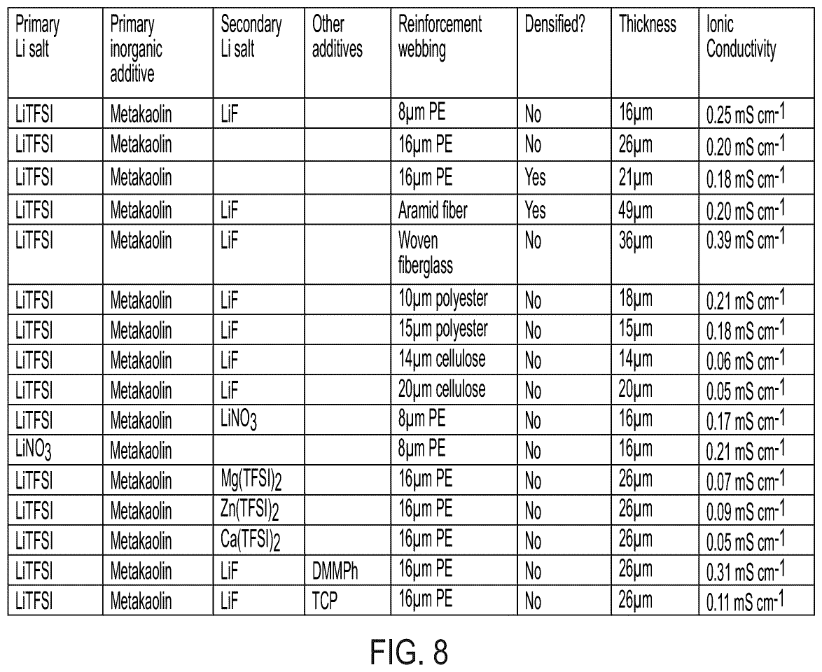

FIG. 9 shows a scanning electron micrograph of PE-based CSE film exhibiting the CSE coating on the underlying PE separator reinforcement.

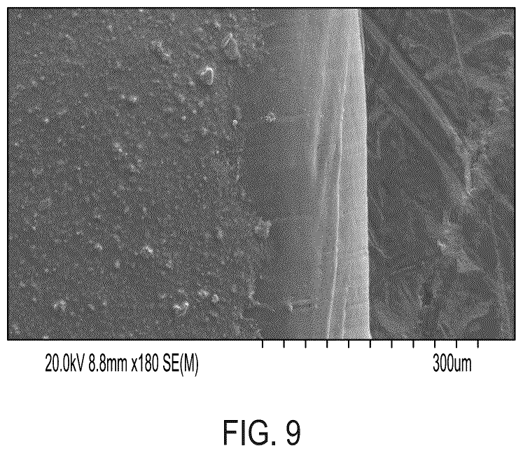

FIG. 10 shows a scanning electron micrograph of woven fiberglass-based CSE separator film in which the presence of the CSE matrix among the glass fibers is visible, as is the dense, continuous coating of CSE formed on the surfaces of the glass fiber textile.

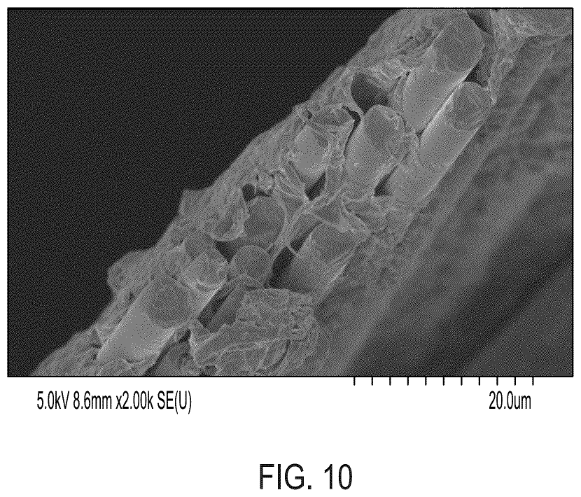

FIG. 11 shows overpotential during galvanostatic cycling of symmetric coin cell with construction: metallic Li ribbon | PE-reinforced CSE separator (with DMMPh additive) metallic Li ribbon (with FIS added at Li-metal/separator interfaces). 200 galvanostatic cycles were performed at 1 mA cm⁻² current density with 2 mAh cm⁻² of lithium being cycled. After over 850 hours of cycling no short circuit or increase in overpotential/polarization was observed.

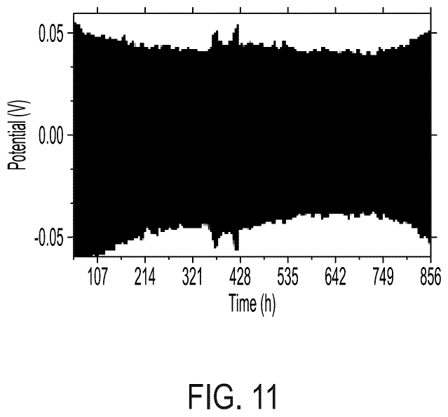

FIG. 12 shows charge (circle) and discharge (square) specific capacity (cathode active material basis) plots for a coin cell with construction: 2.0 mAh cm⁻² NMC811 cathode commercial 8 μm PE separator | metallic lithium ribbon (with copious FIS added to serve as liquid electrolyte). The first five cycles were carried out with symmetric C/5 charge/discharge, cycles 6-10 with symmetric C/2 charge/discharge, cycles 11-15 with symmetric 1C charge/discharge, cycles 16-20 with symmetric 2C charge/discharge, and cycles 21-25 with symmetric C/5 charge/discharge (all cycles between 3V and 4.2V).

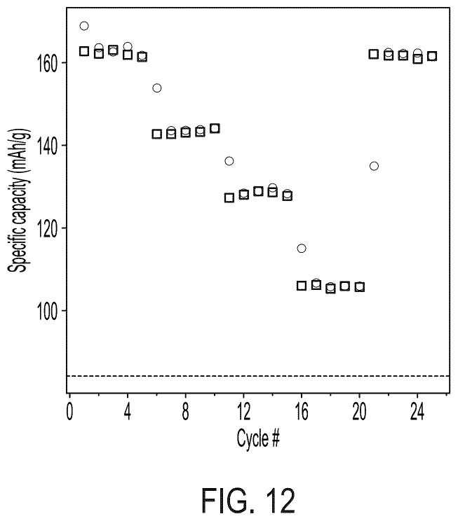

FIG. 13 shows charge (circle) and discharge (square) specific capacity (cathode active material basis) plots for a coin cell with construction: 2.0 mAh cm⁻² NMC811 cathode PE-based freestanding CSE separator | metallic lithium ribbon (with FIS added to reduce separator/Li-metal interfacial impedance and provide ion transport in the cathode). The first five cycles were carried out with symmetric C/5 charge/discharge, cycles 6-10 with symmetric C/2 charge/discharge, cycles 11-15 with symmetric 1C charge/discharge, cycles 16-20 with symmetric 2C charge/discharge, and cycles 21-25 with symmetric C/5 charge/discharge (all cycles between 3V and 4.2V). At all C-rates the coin cell exhibits higher specific capacity than the coin cell made with state-of-the-art PE separator.

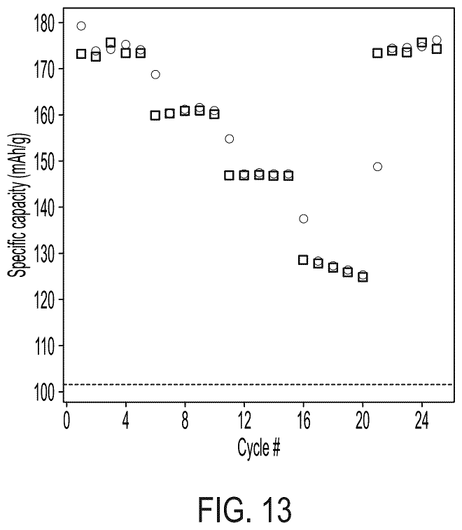

FIG. 14 shows charge (circle) and discharge (square) specific capacity (cathode active material basis) of an 84 mAh 1-layer pouch cell with construction: 3.5 mAh cm⁻² LFP cathode | PE-based freestanding CSE separator |4.0 mAh cm⁻² natural graphite anode with commercial liquid electrolyte, composed of 1.2 M LiPF₆ in 3:7 (w/w) ethylene carbonate/ethylmethyl carbonate and 2 wt % vinylene carbonate, used to provide ionic conductivity in the electrodes' pore networks. The electrode chemistry is representative of a state-of-the-art LIB cell. The cell was cycled with symmetric C/2 charge/discharge between 2.8V and 3.8V with 3.38 atm of external uniaxial compression.

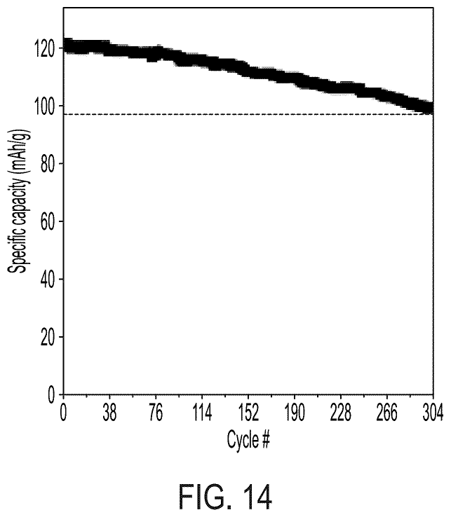

FIG. 15 shows a scanning electron micrograph of deposited Li on a copper foil harvested from a coin cell with the construction: metallic Li ribbon | copper current collector-CSE laminate. The coin cell was assembled in an Argon-filled glovebox and subjected to a 0.2 mA cm⁻² current density that stripped 7 mAh of lithium from the Li-metal ribbon and deposited it on the copper foil laminated to the other side of the PE-reinforced CSE. The dense, SEI-free morphology of the Li-metal is highly desirable and indicative of the separator's ability to transport and plate out metallic lithium without being reduced, generating inactive SEI products, or depositing porous/dendritic lithium.

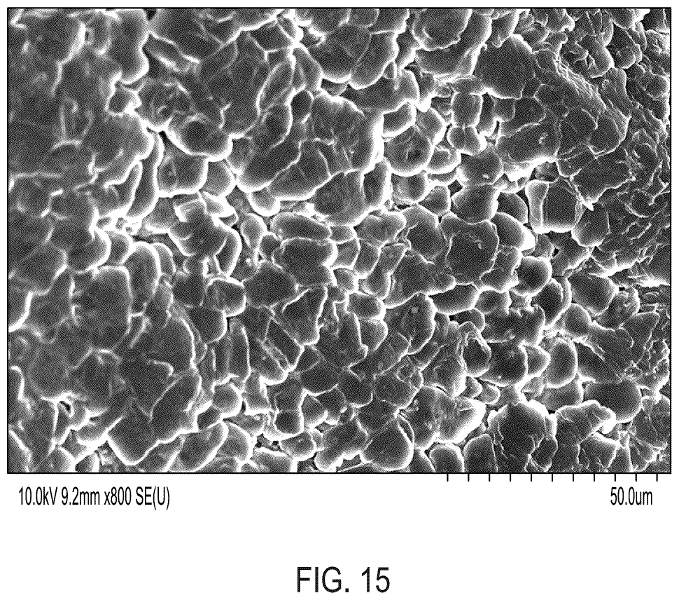

FIG. 16 shows the copper foil disc with evident Li plating harvested from the metallic Li ribbon | copper current collector-CSE laminate coin cell. Such plating was accomplished in a liquid-free coin cell with zero uniaxial compression on the cell component stack, which is indicative of the low interfacial resistivity of the separator, for example, as compared to state-of-the-art solid-state electrolyte separators.

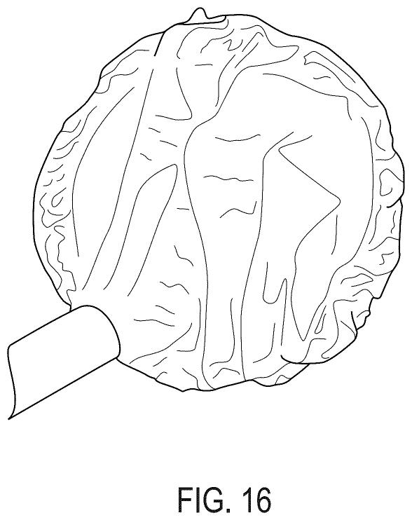

FIG. 17 shows an electrode-CSE laminate produced through the blade coating of CSE slurry onto a cathode tape composed of NMC811 active material, carbon black conductive additive, and PVDF binder. The NMC811 loading of 51 mg cm⁻² (>10 mAh cm⁻² theoretical areal capacity) produced an uncalendered cathode of >200 μm thickness at ˜40% porosity. Sufficient slurry was coated on the surface of the tape and a PE webbing reinforcement added to form a distinct separator layer on top of the tape. The electrode-CSE laminate was then dried in a vacuum oven between 80° C. and 100° C. for 12 hours and densified with calendering.

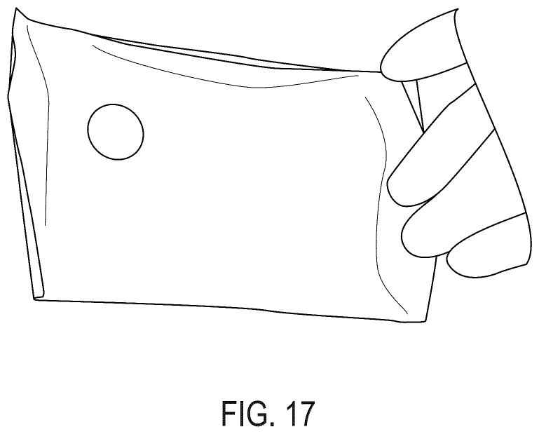

FIG. 18 shows a voltage/specific capacity (cathode active material basis) plot for two C/10 cycles completed by a 18.26 mAh coin cell constructed with the 51 mg cm⁻² electrode-electrolyte laminate and an Li-metal ribbon anode (with a small volume of liquid electrolyte at the interface between the metallic lithium and separator layer to reduce impedance). The discharge specific capacity of ˜175 mAh g⁻¹ indicates the reversible accessibility of 88% of the cathode capacity (based on a theoretical specific capacity for NMC811 of 200 mAh g⁻¹ between 3V and 4.2V) at a current density of ˜1 mA cm⁻².

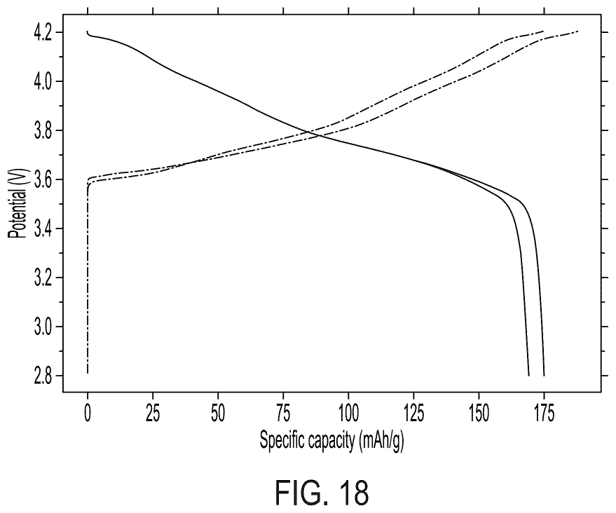

FIG. 19 shows a scanning electron micrograph of the cross section of an electrode-electrolyte laminate produced by coating CSE slurry onto a 17 mg cm⁻² (2.0 mAh cm⁻² theoretical areal capacity) LNMO cathode tape and drying at 80° C. for 12 hours. Despite not having been densified, minimal porosity is visible due to the effective intrusion of the electrolyte into the cathode pore network. Intentional delamination of the distinct PE web-reinforced separator layer is also visible.

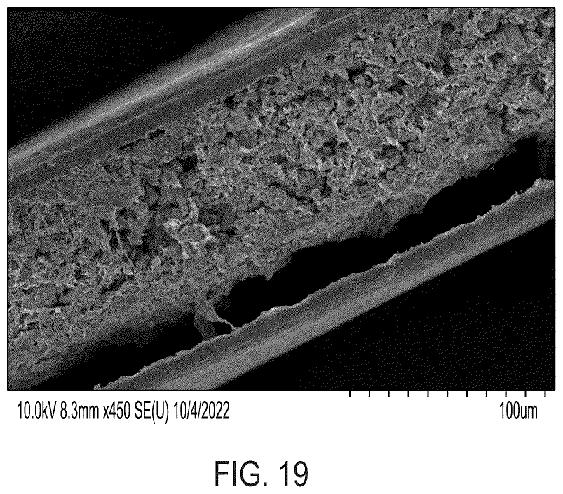

FIG. 20 shows Nyquist plots for two samples of silicon electrode-CSE laminate. A ˜80 μm-thick 100% silicon active material anode tape was blade coated with 1000 μm of CSE slurry. The plasticizer was driven off in a vacuum oven at 80° C. for 12 hours. The electrode-electrolyte laminate was 126 μm-thick before being calendered down to 98 μm. The electrode-electrolyte laminate was cut into discs which were placed between two stainless steel blocking electrodes inside of coin cells. Electrochemical impedance spectra were measured between 0.1 Hz and 1 MHz with 5 mV amplitude at room temperature.

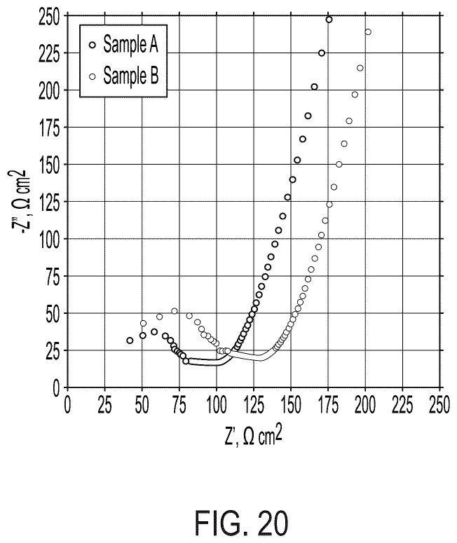

FIG. 21 shows a Nyquist plot of a dry (no liquid present) symmetric coin cells with construction: 1 mAh cm⁻² NMC811 cathode tape | PE-reinforced CSE separator | metallic Li ribbon. The freestanding separator was layered with the cathode tape and the stack was calendered together through a roll press at 60° C. Charge-transfer impedance immediately after assembly of the cell with metallic Li ribbon (triangle) was high due to a lack of uniaxial compression and insulative contaminants on the surface of the Li-metal ribbon. After 24 hours of rest at room temperature the impedance diminished (large circle). After another 48 hours rest at 80° C. (and allowing to cool to room temperature again) the impedance was further reduced (small circle). Hence, rest and/or the application of heat helps overcome the high interfacial resistivity between freestanding CSE separator and metallic lithium.

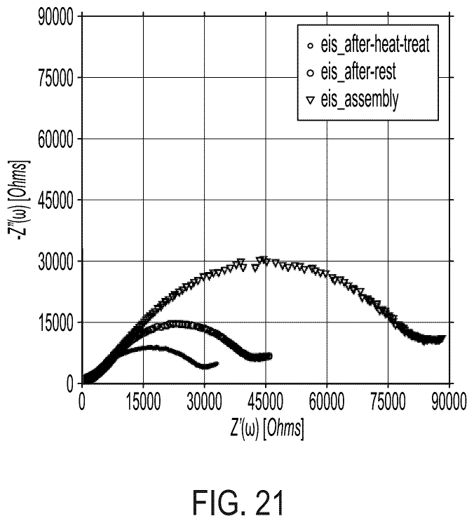

FIG. 22 shows a Nyquist plot of the 1 mAh cm⁻² NMC811 cathode tape | PE-reinforced CSE separator | metallic Li ribbon coin cell following cyclic voltammetry. Five successive cyclic voltammetry scans were carried out from the open circuit potential of ˜3V to 4.2V and back to 3V with a scan rate of 20 mV s⁻¹. The impedance was reduced with each cycle, illustrating that such a technique may also be effective for reduced the impedance between metallic lithium and freestanding CSE separators.

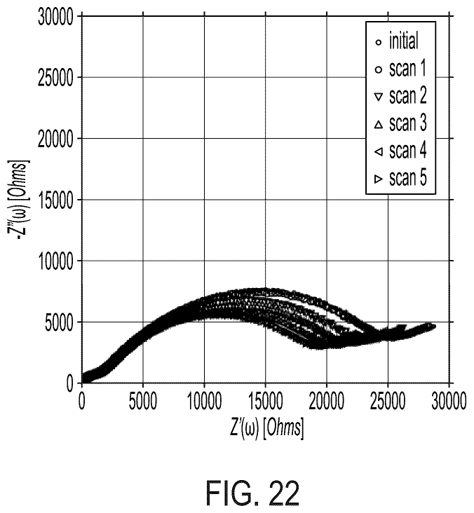

FIG. 23 shows a Nyquist plot of the 1 mAh cm⁻² NMC811 cathode tape | PE-reinforced CSE separator | metallic Li ribbon coin cell following voltage pulses. 600 successive 10 mA cm⁻² current pulses (positive and negative polarity) were applied to the cell, with each pulse being stopped once the cell voltage hit a cutoff of 5V or −5V. Following these pulses the cell impedance was further reduced, showing this to also be a beneficial strategy for reducing the impedance of the interface between Li-metal and freestanding CSE separator.

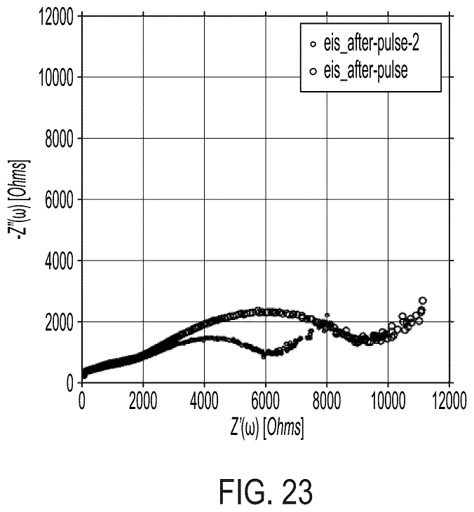

FIG. 24 shows a schematic for a cell design leveraging CSE-based MIEC. On one side of a freestanding CSE separator 242 is coated an MIEC slurry containing cathode active material particles 241. This layer is laminated with an aluminum current collector 240. On the other side of the separator 242 a MIEC slurry coating containing copper microspheres 243 is applied. A current collector 244 may or may not be laminated to this layer.

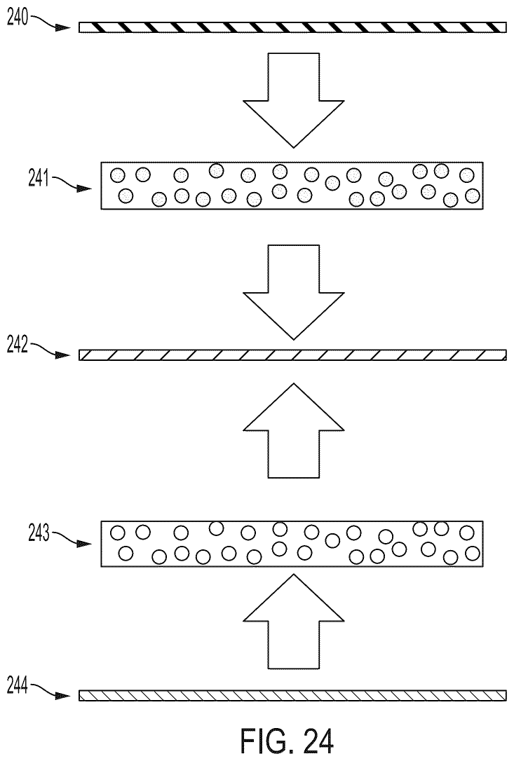

FIG. 25 shows a plot illustrating the relationship between the thickness of the metallic Li layer (x-axis, in μm) plated onto a copper microsphere and the subsequent volume of Li metal that this would represent (y-axis, in μm³). Plating 5 μm of Li on 0.33 mg cm⁻² of copper microspheres would afford 2 mAh cm⁻² of capacity.

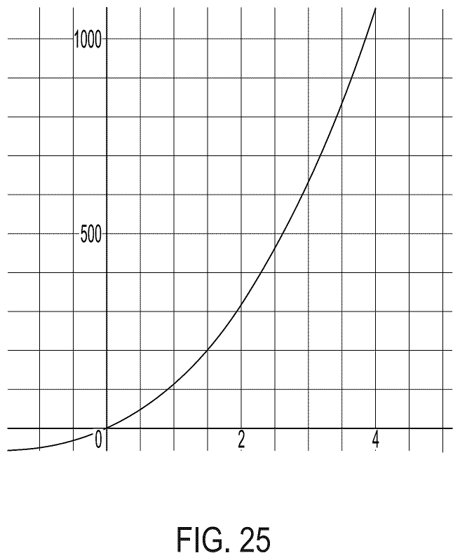

FIG. 26 shows the coulombic efficiency of a coin cell with construction: metallic Li ribbon | copper current collector-CSE laminate (triangles) and another with construction: Li ribbon | copper microsphere-containing CSE-based MIEC (circles). Both coin cells contained FIS as well. The coin cells were subjected to galvanostatic cycling of 2 mAh cm⁻² of areal capacity at room temperature at 1.0 mA cm⁻² current density. The CSE-based MIEC exhibits consistently higher coulombic efficiencies across over 80 cycles indicating an improvement in lithium plating/stripping characteristics and reversibility.

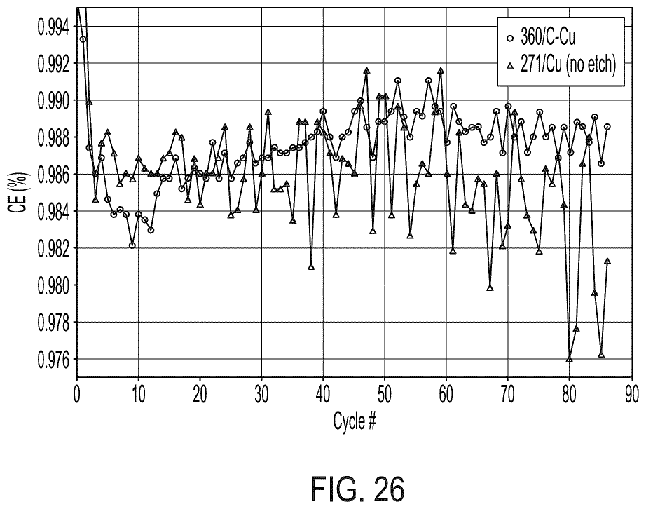

FIG. 27 shows a scanning electron micrograph of copper microsphere-containing CSE-based MIEC laminated with a carbon current collector. The carbon is 12 μm thick.

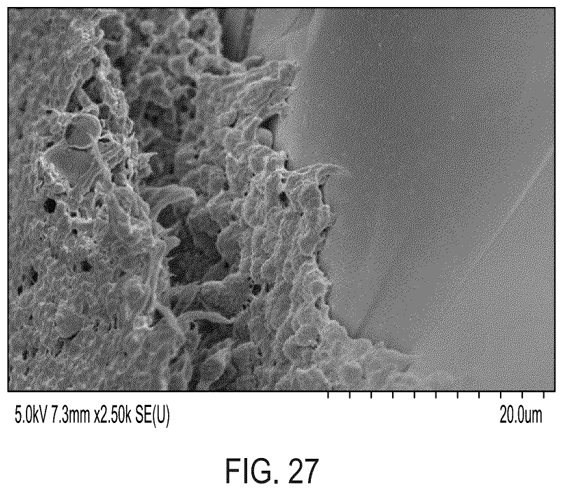

FIG. 28 shows a metallic lithium coating established on a carbon textile current collector with a lithiophilic coating. A coating of zinc oxide (ZnO) nanoparticles was first established on the carbon textile by immersing it in a zinc acetate/methanol solution. The methanol was then driven off and the zinc acetate decomposed into ZnO in a furnace. Metallic lithium was melted down in a copper crucible in an argon-filled glovebox and the ZnO-coated carbon textile disc was immersed in the lithium to produce a melt-infused lithium metal coating. The woven carbon textile possesses a three-dimensional surface morphology which increases specific surface are and thus reduces effective current density at the surface.

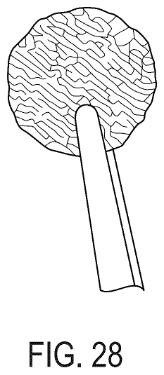

FIG. 29 shows a charge (circle) and discharge (square) specific capacity (cathode active material basis) plots for a coin cell with construction: 2.0 mAh cm⁻² NMC811 cathode PE-based freestanding CSE separator | metallic lithium ribbon (with FIS added). The cell was subjected to symmetric charge/discharge at 1 C rate at room temperature between 3V and 4.2V.

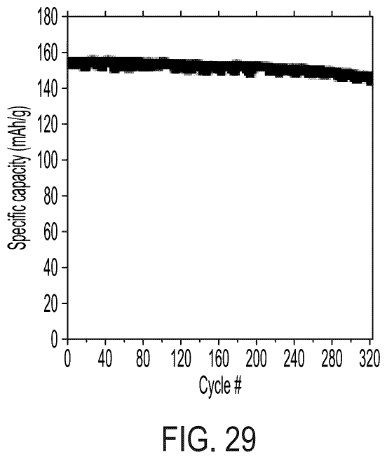

FIG. 30 shows a charge (circle) and discharge (square) specific capacity (cathode active material basis) plots for a coin cell with construction: 2.0 mAh cm⁻² NMC811 cathode PE-based freestanding CSE separator | metallic Li melt-infused, ZnO-coated carbon textile (with small volume of liquid added to reduce separator/Li-metal interfacial impedance and provide ion transport in the cathode). The cell was subjected to symmetric charge/discharge at 1 C rate at room temperature between 3V and 4.2V. A higher specific capacity is maintained than was achieved with Li-metal ribbon, suggesting that polarization and charge/discharge hysteresis are improved at high current density by the melt-infused ZnO-coated carbon textile.

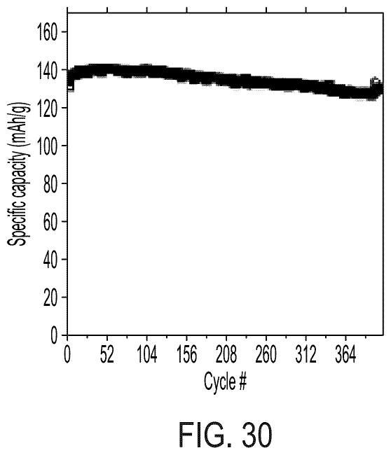

FIG. 31 shows a metallic lithium layer formed in situ inside of a pouch cell on the surface of PE-based CSE freestanding separator via electrodeposition.

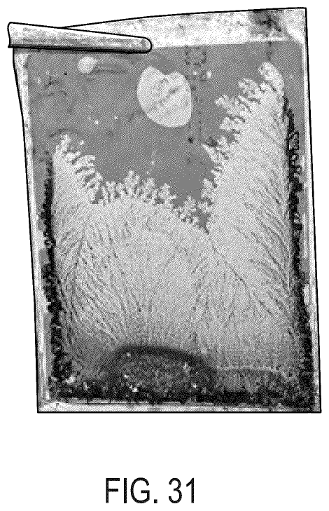

FIG. 32 shows a schematic for how a metallic lithium metal layer 335 may be electrodeposited on the surface of CSE separator 332 in situ in a cell. Depositing the layer requires a sacrificial Li anode 331, an Li seed 333, and a tab 334. As shown in FIG. 33, Li metal layer 335 is grown on the CSE separator 332.

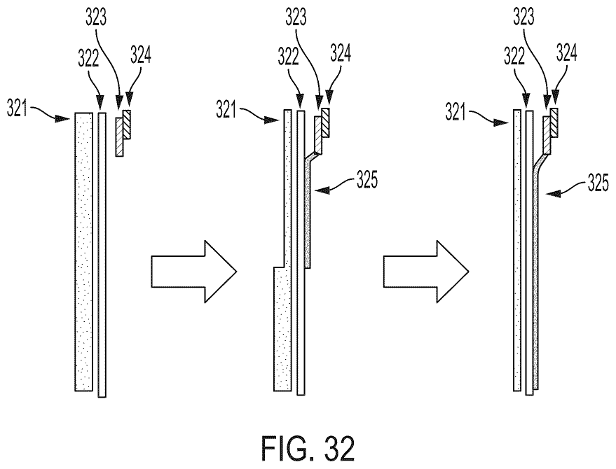

FIG. 33 is a schematic of a coin cell cross section.

### DETAILED DESCRIPTION

The present teachings are described more fully hereinafter with reference to the accompanying drawings, in which the present embodiments are shown. The following description is presented for illustrative purposes only and the present teachings should not be limited to these embodiments.

In the following description, various aspects of the present disclosure are described. For purposes of explanation, specific configurations and details are set forth in order to provide a thorough understanding of the present disclosure. However, it will be apparent to one skilled in the art that the present disclosure may be practiced without the specific details presented herein. Furthermore, well-known features may have been omitted or simplified in order not to obscure the present disclosure. With specific reference to the drawings, it is stressed that the particulars shown are by way of example for purposes of illustrative discussion of the present disclosure only and are presented in the cause of providing what is believed to be most useful and readily understood description of the principles and conceptual aspects of the disclosure. In this regard, no attempt is made to show structural details of the disclosure in more detail than is necessary for a fundamental understanding of the disclosure, the description taken with the drawings making apparent to those skilled in the art how the several forms of the disclosure may be embodied in practice.

The disclosure is not limited in its application to the details of construction and the arrangement of the components set forth in the following description or illustrated in the drawings. The disclosure is applicable to other disclosures that may be practiced or carried out in various ways as well as to combinations of the disclosure. The phraseology and terminology employed herein are for the purpose of description and should not be regarded as limiting.

The present disclosure provides efficient and economical methods and mechanisms for improving the cycling lifetime of lithium-ion batteries and thereby provides improvements to the technological field or energy storage.

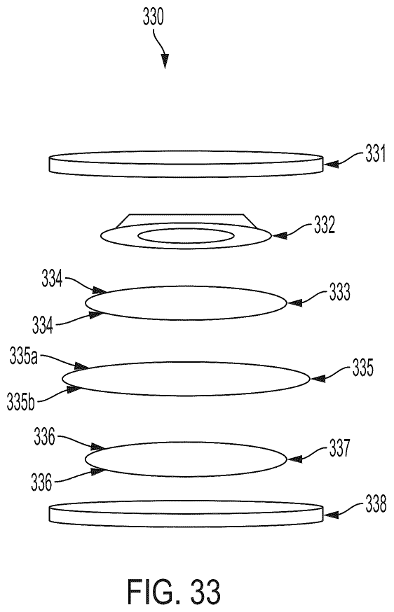

FIG. 33 shows a schematic of a battery button cell, though this disclosure is not limited to button cell batteries. The button cell battery 330 has a negative case 331 and a positive case 338. A spring 332 sits next to the negative case 331. A separator 335 is sandwiched between a cathode (negative electrode) 333 and an anode (positive electrode) 337.

A composite solid electrolyte (CSE) 335a, 335b may be provided on one or both sides of the separator 335. Alternatively, the CSEs 334, 336 may be provided on the cathode 333 or anode, 337, respectively, or on a current collector therefor. The CSEs 335a, 335b, 334, 336 may be the same or different in composition.

A composite solid electrolyte (CSE) 335a, 335b can hybridize both polymeric and ceramic materials. The ceramic can be either active or inactive, depending on whether it possesses intrinsic ionic transport properties or enhances the ion transport capability of the surrounding continuous polymer matrix. The CSEs are dense with little or no porosity and may or may not contain lithium salt or plasticizer material. One type of CSE is a Lithium-Ion Solid Ionic Composite (LISIC), a polymer-ceramic composite solid electrolyte for lithium-ion batteries (LIBs) and lithium-metal batteries containing an aluminosilicate ceramic, a second component comprising polyvinylidene fluoride polymer, and a third component comprising a lithium salt.

A CSE 335a, 335b may be processed as a liquid slurry by adding a solvent plasticizer and this liquid slurry may be applied to the surfaces of substrates. These substrates may be rechargeable lithium battery separators or other continuous, porous, and mechanically-reinforcing webs 335, electrodes 333, 337, current collectors thereon, or other components. The plasticizer may then be eliminated to produce a solid, dense CSE phase on top of and within rechargeable lithium battery materials and components.

The CSE 335a, 335b, 334, 336 is comprised of one or multiple polymers, lithium salts, solvent plasticizers, active (intrinsically Li-ion conductive) inorganic additive particles, inactive (not intrinsically Li-ion conductive) inorganic additive particles, continuous or discontinuous reinforcement phases, and/or other liquid or solid additives.

The polymer may be polyvinylidene fluoride (PVDF), PVDF-co-hexafluoropropylene (HFP), PVDF grafted with functional groups such as acrylic or other functional groups, or other classes of fluoropolymer or non-fluorinated polymer.

The lithium salts may include one or a combination of lithium bis(trifluoromethanesulfonyl)imide (LiTFSI), lithium nitrate (LiNO₃), lithium fluoride (LiF), lithium perchlorate (LiClO₄), lithium acetate (LiC₂H₃O₂), or other suitable lithium salt.

The solvent plasticizer may include one or a combination of triethyl phosphate (TEP), trimethyl phosphate (TMP), dimethyl formamide (DMF), dimethylacetamide (DMAC), n-methyl-2-pyrrolidone (NMP), or other suitable liquid solvent plasticizer.

The active inorganic additive may include one or a combination of lepidolite, lithium-lanthanum-zirconate (LLZO), or other suitable intrinsically lithium-conducting inorganic additive. The LLZO may be doped with tantalum, niobium, aluminum, or other suitable dopant that enhances the ionic conductivity or other properties.

The inactive inorganic additive may include one or a combination of metakaolin, metahalloysite, alumina, silica, or other suitable inactive inorganic additive. The inorganic additive may be modified to increase its x-ray amorphousness to improve the performance of the CSE. For example, metakaolin may be calcined at an optimized temperature between 400° C. and 1200° C. to minimize its crystallinity. To reduce the particle size and increase its surface activity, metakaolin may be exfoliated using a urea/water solution by first allowing the metakaolin particles to soak in the solution and uptake urea into their interlayer spaces. Subsequent calcination of the urea-intercalated metakaolin particles exfoliates the aluminol/siloxane layers.

The continuous or discontinuous reinforcement phases may include one or a combination of porous polyethylene (PE) LIB separator, porous polypropylene (PP) separator, porous cellulose webbing, woven or chopped glass fiber, woven or chopped aramid fiber, porous polyester webbing, or other suitable reinforcement material. Cellulose may be treated with a Na₂Cu(OH)₄ complex copper hydroxide solution made from the reaction of sodium hydroxide with copper sulfate or other copper salt to functionalize its surfaces for the coordination of lithium percolation networks once infused with CSE.

Other additives may include one or a combination of non-lithium salt such as zinc bis(trifluoromethanesulfonyl)imide, magnesium bis(trifluoromethanesulfonyl)imide, calcium bis(trifluoromethanesulfonyl)imide, or other suitable salt. Other additives may also include one or a combination of flame-retardant liquid solvent such as tris(2-chloroethyl)phosphate (TCP), dimethyl methylphosphonate (DMMPh), or other suitable flame retardant.

Other additives may also include (2-chloroethyl)phosphonic acid (ethephon), phenyl phosphonic acid (PPA), or other suitable phosphonic acid. Ethephon or PPA may be used in combination with lithium acetate or other suitable lithium salt to graft PVDF with an organic lithium phosphonic salt. For example, lithium acetate will interact with the acidic groups of PPA to form a dilithium salt of PPA. Grafting such salts to PVDF is useful when using a CSE slurry based on TEP solvent plasticizer and LLZO active inorganic additive. TEP will have a strong alkalescent interaction with the surfaces of LLZO that may dehydrofluorinate the PVDF. The grafting of lithium phosphonic salts prevents PVDF dehydrofluorination.

The addition of solvent plasticizers allows the CSE 335a, 335b to be processed in a liquid slurry form. The slurry may be applied as a coating to substrates 335 through various methods including but not limited to slot-die coating, spray coating, immersion coating, blade coating, etc.

The substrate to which the CSE slurry is applied may be a reinforcement phase such as a porous continuous webbing composed of the aforementioned reinforcement phase materials. The plasticizer may be fully or partially removed from the slurry to solidify the CSE on and within the webbing to produce freestanding solid electrolyte separator films. This film may be densified using methods such calendering. A composite solid electrolyte slurry of one composition may be used one side of the webbing while a slurry of a different composition may be used on the other side of the webbing, with the compositions optimized for the electrodes that each side of the separator will face.

The plasticizer may be removed using heat (drying), vacuum drying, mechanical removal (for example, roll pressing), or phase inversion. Phase inversion constitutes the exposure of the CSE slurry coating to a liquid in which it is insoluble. For instance, phase inversion may be accomplished by immersing the CSE slurry in deionized water. The water may be a saturated or unsaturated lithium salt solution to prevent the removal of lithium from the CSE slurry due to proton exchange. Anhydrous ethanol or other suitable solvents may also be used to prevent proton exchange.

The substrate to which the CSE slurry is applied may be a battery electrode 333, 337, such as a tape composed of electrode active material, binder, and conductive additive coated onto a metal foil. The slurry may flow and infiltrate into the pore network of the electrode and/or establish a distinct coating on top of the electrode. A reinforcement webbing may be added to a distinct slurry coating on top of the electrode to support a discrete separator layer. The plasticizer may be fully or partially removed from the slurry to solidify the CSE phase on and within the electrode and webbing. The electrode-CSE laminate may be densified using methods such as calendering. The electrode-CSE laminate may also be treated with a vacuum bagging technique to help facilitate thorough intrusion of CSE slurry into the electrode pore network as well as sufficient plasticizer removal.

The current collector may be a metal foil such as copper, aluminum, zinc, tin, nickel, magnesium, etc., or a non-metal material such as carbon textile. The current collector may be lithiophilic or lithiophilic or be coated with lithiophilic material such as zinc oxide (ZnO) nanoparticles. The current collector may be two-dimensional or have a three-dimensional surface morphology or microstructure. A reinforcement webbing may be added to support the formation of a distinct separator layer 335, 335a, 335b. Plasticizer may be fully or partially removed from the slurry to solidify it on the current collector. The current collector-electrolyte laminate may be densified using methods such as calendering.

A lithiophilic ZnO nanoparticle coating may be established on the surface of the current collector by first mixing a saturated solution of zinc acetate (or other suitable zinc salt) in methanol (or other suitable solvent). The current collector may be immersed in the solution before being fired in a furnace to decompose the zinc acetate into ZnO nanoparticles.

The substrate to which the CSE slurry is applied may include a current collector 335a, 335b, 334, 336 with a metallic lithium coating constituting a lithium-metal anode. The metallic lithium coating may be produced through melt-infusion, vapor deposition, electrodeposition, or other methods. Electrodeposition may be accomplished in situ inside of a lithium battery cell. The substrate itself may also be a pure lithium metal foil. A reinforcement webbing may be added to support the formation of a discrete separator layer, 335, 335a, 335b. The current collector-CSE laminate may be densified using methods such as calendering.

In situ electrodeposition of a metallic lithium coating may be accomplished using a sacrificial metallic lithium anode or lithium inventory from a non-sacrificial operational electrode.

A passivating, protective artificial solid electrolyte interphase composed of a lithium-zinc complex may be established on the surface of the metallic lithium coating. This may be achieved by washing the surface of the metallic lithium using a solution of zinc chloride (ZnCl₂), Zn(TFSI)₂, zinc fluoride (ZnF₂), or other suitable zinc salt in tetrahydrofuran (THF), 1,2-dimethoxy ethane (DME), or other suitable solvent and then rinsing with pure solvent. Lithium-zinc complexes will spontaneously form from such treatment due to the reactivity of the metallic lithium surface.

Electrode active material particles and electronically conductive additives such as amorphous carbon particles or carbon nanotubes may be added to the CSE slurry to form a mixed ionic-electronic conductor (MIEC) slurry. The MIEC slurry may be coated onto current collector materials and the plasticizer fully or partially removed to solidify the CSE matrix and produce a battery electrode, 333, 334, 336, 337. The CSE matrix serves the combined role of binder for the electrode active material as well as Li⁺-conductive phase in the electrode. A reinforcement webbing may be added to support the formation of a discrete separator layer, 335, 335a, 335b. The CSE-based MIEC electrode may be densified using methods such as calendering.

The active material particles in the CSE-based MIEC may be monocrystalline or polycrystalline cathode active material particles including one or a combination of LiCoO₂, LiNiO₂, LiMnO₂, LiMn₂O₄, LiNi_{A}Mn_{B}CO_{C}O₂ (0<A<1, 0<B<1, 0<C<1, A+B+C=1), LiNi_{A}Mn_{B}Co_{C}O₂ (0<A<2, 0<B<2, 0<C<2, A+B+C=2), LiNi_{1-Y}Co_{Y}O₂ (0≤Y<1), LiCo_{1-Y} Mn_{Y} O₂ (0≤Y<1), LiNi_{1-Y}Mn_{Y}O₂ (0≤Y<1), LiMn_{2-Z}Ni_{Z}O₄ (0<Z<2), LiMn_{2-Z}Co_{Z}O₄ (0<Z<2), LiCoPO₄, LiFePO₄. The cathode active material may include performance-improving dopants such as germanium, titanium, or other dopants.

The active material particles in the CSE-based MIEC may include one or a combination of graphitic anode materials such as natural graphite, artificial graphite, or other related anode active material. The active anode material particle may also include one or combination of silicon anode materials such as silicon oxide, pure silicon, or other related material. The CSE-based MIEC may contain a blend of graphitic and silicon-based anode active materials.

The active material particles in the CSE-based MIEC may include metal microparticles or nanoparticles, including one or a combination of copper, magnesium, zinc, or other suitable metal or metal alloy.

The active material particles in the CSE-based MIEC, whether cathode active material, anode active material, or metal may or may not be coated with lithium aluminum titanium phosphate (LATP) or LLZO to improve their stability in the MIEC.

A densified or non-densified freestanding CSE separator 335, 335a, 335b, electrode-CSE laminate 333, 334, 336, 337, current collector-CSE laminate 333, 334, or CSE-based MIEC electrode 334, 336, 335a, 335b may additionally have their surfaces comprised of CSE phase coated with lithiophilic material such as magnesium nanoparticles or metallic lithium. This may be accomplished using vapor deposition, electrodeposition, or other methods. Electrodeposition may be accomplished in situ inside of a lithium battery cell using a sacrificial lithium-metal electrode or the lithium inventory of a non-sacrificial cathode.

Rechargeable lithium batteries may be assembled by layering freestanding composite solid electrolyte separator film 335 between cathode 333 and anode 337. Liquid electrolyte or FIS (shown schematically as an option for 334, 336) may be added to improve ion transport at the interfaces between the electrodes 333, 337 and the separator 335 and/or if the electrodes are porous and their pore networks are not accessible to the separator. A different liquid electrolyte may be used on the cathode 343 side than on the anode 337 side.

Rechargeable lithium batteries may also be assembled by using electrode-CSE laminate, current collector-CSE laminate, or CSE-based MIEC electrode in the place of an electrode and electrolyte.

More specifically, a cathode 337 active material may preferably be a lithium-containing transition metal oxide, spinel, olivine, or disordered rock salt, for example, any one material or a mixture of at least two materials selected from group consisting of LiCoO₂, LiNiO₂, LiMnO₂, LiMn₂O₄, LiNi_{A}Mn_{B}CO_{C}O₂ (0<A<1, 0<B<1, 0<C<1, A+B+C=1), LiNi_{A}Mn_{B}CO_{C}O₂ (0<A<2, 0<B<2, 0<C<2, A+B+C=2), LiNi_{1-Y}Co_{Y}O₂ (0<Y<1), LiCo_{1-Y}Mn_{Y}O₂ (0≤Y<1), LiNi_{1-Y}Mn_{Y}O₂ (0≤Y<1), LiMn_{2-Z}Ni_{Z}O₄ (0<Z<2), LiMn_{2-Z}Co_{Z}O₄ (0<Z<2), LiCoPO₄, LiFePO₄.

The anode 333 of a lithium battery can be made from various materials, including carbon-based materials, lithium-metal, silicon-based active materials, and lithium metal oxide materials like Li₄Ti₅O₁₂ (LTO). Carbon is the most commonly used anode material and can be either low-crystallinity or high-crystallinity. Low-crystallinity carbon includes soft carbon and hard carbon, while high-crystallinity carbon can be natural graphite, Kish graphite, pyrolytic carbon, mesophase pitch-based carbon fiber, meso-carbon microbeads, mesophase pitches, or high-temperature sintered carbon derived from petroleum or coal tar pitch. The anode may also contain a binding agent, such as Poly(vinylidene fluoride-co-hexafluoropropene) (PVDF-co-HFP), PVDF, polyacrylonitrile (PAN), polymethylmethacrylate (PMMA), polyacrylic acid (PAA), or carboxymethyl cellulose (CMC) with styrene-butadiene rubber (SBR).

The separator 335 in a lithium battery can be made from a common porous polymer film. These films are made from materials such as ethylene homopolymer, propylene homopolymer, polyethylene/butene copolymer, ethylene/hexene copolymer, or ethylene/methacrylate copolymer, either as a single layer or in a laminated structure. In some cases, the separator can also be a common porous non-woven fabric made from materials like glass fiber with a high melting point or polyethylene terephthalate fiber.

The composite solid electrolyte material can be tuned for optimized properties by varying the composition and proportion of the polymers, solvent plasticizers, lithium salts, active inorganic additives, inactive inorganic additives, reinforcement phases, and other additives. The polymer lends elastic properties that improve the electrolyte's resistance to cracking from internal strains inside battery cells. The other characteristics of CSE are flexibility and durability. CSE used in the present disclosure prevents short-circuit caused by dendrites and is thermally stable to >250° C. which is a much safer alternative to carbonate-based LIB liquid electrolytes.

Functional interphase stabilizers (FISs) may also be added to the surfaces of the anode 333 and/or cathode 337, respectively. The functional interphase stabilizers may include a source of Li⁺ mobility. Any lithium salt material commonly used in liquid electrolytes for LIBs may be used. The lithium salt may be representatively any one material or a mixture of at least two materials selected from the group consisting of:
Lithium bis(trifluoromethanesulfonyl)imide (LiTFSI),
Lithium bis(fluoromethanesulfonyl)imide (LiFSI),
Lithium fluoride (LiF),
Lithium nitrate (LiNO₃),
Lithium difluoro(oxalato)borate (LiDFOB),
Lithium iodide (LiI),
Lithium Difluorophosphate (LiPO₂F₂),
Lithium hexafluorophosphate (LiPF₆).

Lithium salt is preferably used in the concentration range of 0.1 M to 8.0 M. If the concentration of the lithium salt is less than 0.1 M, the concentration is low, thereby reducing the performance of the FIS. On the other hand, if the concentration of the lithium salt is greater than 8.0 M, the viscosity of the stabilizer increases, thereby reducing the mobility of lithium ions and degrading the performance at low temperatures.

The functional interphase stabilizers may include an organic solvent. Any ether- and carbonate-based material commonly used in an electrolyte of a lithium-ion rechargeable battery may be used. The organic compound may include as representative examples any one material or a mixture of at least two materials selected from the group consisting of:
Ethers, including:
   1,2-Dimethoxy ethane (DME), and/or
   1,1-Diethoxy ethane (DEE),
Hydrofluoroethers (HFEs), including:
   Methyl 1,1,2,2 tetrafluoroethyl ether (TFME), and/or
   1,1,2,2-tetrafluoroethyl-2,2,3,3-tetrafluoropropyl ether (TTE),
   1,2-(1,1,2,2-Tetrafluoroethoxy)ethane,
   1,1,2,2-Tetrafluoroethyl-1H,1H,5H-octafluoropentyl ether,
Fluorinated carbonates, including Fluoroethylene carbonate (FEC),
Organosulfurs, including:
   Dimethyl sulfide (DMS),
   Dimethyl sulfoxide (DMSO), and/or
   Sulfolane (SL),
Phosphates, including:
   Triethyl phosphate (TEP),
   Trimethyl phosphate (TMP),
   Dimethyl methylphosphonate (DMMPh), and/or
   Triphenyl phosphate (TPhP),
Phosphites, including Tris(trimethylsilyl)phosphite (TMSPi),
Cyclic ethers, including Tetrahydrofuran (THF),
Fluorinated ortho esters, including Tris(2,2,2-trifluoroethyl) orthoformate (TFEO),
Carbonates, including Vinylene carbonate (VC),
Nitriles, including Acetonitrile,
Methyl beta-L-fucopyranoside (MFB),
Other heterocyclic organic solvents, including Dioxolane (DOL).

Among the carbonate-based organic solvents, cyclic carbonates such as EC and PC may be preferably used since they have high viscosity such that they show high dielectric constants and thus dissociate lithium salts in the FIS. Also, if a linear carbonate with low viscosity and low dielectric constant such as DMC and EDC is mixed with a cyclic carbonate at a suitable ratio, it is possible to make an FIS with high electronic conductivity.

The FIS for an LIB or LMB is injected into an electrode structure having an anode 333, a cathode 337 and a dense active CSE separator 335 interposed between the anode 333 and the cathode 337, thereby making an LIB or LMB cell. The anode 333 and the cathode 337 may be from any kind of material commonly used in making a lithium-ion rechargeable battery, such as those discussed herein.

The foregoing description is a specific embodiment of the present disclosure. It should be appreciated this this embodiment is described for purposes of illustration only, and that numerous alterations and modifications may be practiced by those skilled in the art without departing from the spirit and scope of the disclosure. It is intended that all such modifications and alterations be included insofar as they come within the scope of the invention as claimed or the equivalent thereof.

As used herein, the term “about” indicates values generally within ±5%, as appropriate (e.g., a lower range limit is −5% and an upper range limit being +5%).

What it is claimed is:

1. A composite solid electrolyte (CSE), comprising:
at least one polymer;
at least one lithium salt;
a solvent plasticizer;
at least one inorganic additive particle;
a substrate;
one or more liquid or solid additive.

2. The composite solid electrolyte (CSE) of claim 1, wherein the substrate is a continuous porous webbing selected from the group consisting of polyethylene, polypropylene, polyolefin, a microporous film, ethylene/butene copolymer, ethylene/hexene copolymer, ethylene/methacrylate copolymer, woven fabric, woven fabric with glass fiber, woven fabric with polyethylene terephthalate fiber, cellulose, aramid fiber, another organic or synthetic fiber, or combination thereof.

3. The composite solid electrolyte (CSE) of claim 1, wherein the substrate is a battery electrode, such as conventional battery electrode or a tape composed of electrode active material, binder, and conductive additive coated onto a metal foil.

4. The composite solid electrolyte (CSE) of claim 3, further comprising a reinforcement webbing on the battery electrode to support a discrete CSE separator layer.

5. The composite solid electrolyte (CSE) of claim 1, wherein the substrate is a current collector having at least one of copper, aluminum, zinc, tin, nickel, magnesium, or carbon textile.

6. The composite solid electrolyte (CSE) of claim 5, wherein the current collector may be lithiophilic or lithiophilic or be coated with at least one lithiophilic material selected from the group of zinc-oxide nanoparticles, magnesium nanoparticles, and metallic lithium, and wherein the current collector has a two- or three-dimensional surface morphology or microstructure.

7. The composite solid electrolyte (CSE) of claim 5, wherein the current collector is a lithium metal foil, or a foil coated with metallic lithium.

8. The composite solid electrolyte (CSE) of claim 1, wherein the CSE is configured to prohibit short-circuit of a battery by serving the function of an ionically-conductive but electronically-insulative barrier between a cathode and an anode of a battery cell.

9. The composite solid electrolyte (CSE) of claim 1, wherein the CSE mitigates dendrite growth on an anode of a battery cell and prevents dendrites from short-circuiting the battery cell by maintaining an operating rigidity which is impenetrable to dendrites.

10. A method of making a composite solid electrolyte (CSE) comprising: providing, as a liquid slurry, at least one polymer, at least one lithium salt, a solvent plasticizer, at least one inorganic additive particle, and one or more liquid or solid additives; coating a substrate with the liquid slurry.

11. The method of making the composite solid electrolyte (CSE) of claim 8, wherein the coating step is performed using at least one of slot-die coating, spray coating, immersion coating, and blade coating.

12. The method of making the composite solid electrolyte (CSE) of claim 8, further comprising the step of removing the solvent plasticizer from the liquid slurry to solidify the liquid slurry phase on or within the substrate.

13. The method of making the composite solid electrolyte (CSE) of claim 8, further comprising the step of coating a second side of the substrate with a second liquid slurry, the second liquid slurry being the same or different than the liquid slurry.

14. The method of making the composite solid electrolyte (CSE) of claim 8, wherein the slurry may infiltrate a pore network of the substrate or establish a coating on top of the substrate.

15. The method of making the composite solid electrolyte (CSE) of claim 8, wherein the substrate is a continuous porous webbing selected from the group consisting of a polypropylene separator, polyethylene separator, or a polypropylene/polyethylene separator.

16. The method of making the composite solid electrolyte (CSE) of claim 8, wherein the substrate is a battery electrode, such as conventional battery electrode or a tape composed of electrode active material, binder, and conductive additive coated onto a metal foil.

17. The method of making the composite solid electrolyte (CSE) of claim 14, further comprising the providing a reinforcement webbing on the battery electrode to support a discrete CSE separator layer and wherein the slurry solidifies on and within the reinforcement webbing.

18. The method of making the composite solid electrolyte (CSE) of claim 14, further comprising the step of vacuum bagging the electrode and slurry to facilitate thorough intrusion of the slurry into a pore network of the electrode and plasticizer removal.

19. The method of making the composite solid electrolyte (CSE) of claim 8, further comprising the step of mixing the slurry with electrode active material particles and electronically conductive additives such as amorphous carbon particles to produce a mixed ionic-electronic conductor (MIEC) slurry.

20. The method of making the composite solid electrolyte (CSE) of claim 8, further comprising the step of calendering.

21. The method of making the composite solid electrolyte (CSE) of claim 8, further comprising the steps of melt-infusion, vapor deposition, and electrodeposition.

22. A battery comprising:
an anode;
a cathode;
a separator;
a current collector;
a functional interphase stabilizer having an organic nonaqueous solvent and a lithium salt in solution with the organic nonaqueous solvent.

23. The battery of claim 22, wherein the nonaqueous solvent includes at least one of 1,2-Dimethoxyethane (DME), 1,1,2,2-Tetrafluoroethyl-2,2,3,3-tetrafluoropropyl ether (TTE), Dimethyl sulfide (DMS), Fluoroethylene carbonate (FEC), Vinylene carbonate, Dimethyl sulfoxide (DMSO), Dimethyl methylphosphonate (DMMPh), Trimethyl phosphate (TMP), Tris(trimethylsilyl)phosphite (TMSPi), Dioxolane (DOL), 1,1-Diethoxyethane (DEE), Tetrahydrofuran (THF), Triphenyl phosphate (TPhP), Tris(2,2,2-trifluoroethyl) orthoformate (TFEO), Vinylene carbonate (VC), Triethyl phosphate (TEP), Sulfolane (SL), Methyl 1,1,2,2 Tetrafluoroethyl ether (TFME), Methyl beta-L-fucopyranoside (MFB), 1,2-(1,1,2,2-Tetrafluoroethoxy)ethane, 1,1,2,2-Tetrafluoroethyl-1H,1H,5H-octafluoropentyl ether, or Acetonitrile.

24. The battery of claim 22, wherein the lithium salt is selected from the group consisting of at least one of Lithium bis(trifluoromethanesulfonyl)imide (LiTFSI), Lithium bis(fluoromethanesulfonyl)imide (LiFSI), Lithium fluoride (LiF), Lithium nitrate (LiNO3), Lithium difluoro(oxalato)borate (LiDFOB), Lithium iodide (LiI), Lithium Difluorophosphate (LiPO₂F₂), or Lithium hexafluorophosphate (LiPF₆).

25. The battery of claim 22, wherein the separator is selected from the group consisting of a polymer membrane or a multilayered film of polyethylene, polypropylene, polyolefin, a microporous film, ethylene/butene copolymer, ethylene/hexene copolymer, ethylene/methacrylate copolymer, woven fabric, woven fabric with glass fiber, woven fabric with polyethylene terephthalate fiber, cellulose, aramid fiber, another organic or synthetic fiber, ceramic, composite polymer-ceramic solid-state electrolyte, or a combination thereof.

26. The battery of claim 22, wherein the cathode is selected from a group consisting of lithium-containing spinels such as LiNi_{0.5}Mn_{1.5}O₄ (LNMO), olivines such as lithium iron-phosphate (LFP), transition metal oxides of the form LiMeOₓ wherein Me is one or more metal selected from nickel (Ni), cobalt (Co), manganese (Mn) and aluminum (Al), Li and O represent one or more respective lithium and oxygen atoms, and x represents the number of oxygen atoms, or other suitable cathode active materials containing lithium or reliant upon prelithiation.

27. The battery of claim 22, wherein the anode is selected from the group consisting of a carbon-based material including artificial and natural graphite, silicon-based materials including pure silicon and silicon-oxide, silicon-carbon composites, lithium titanate, lithium vanadate, or other related lithium metal oxide anode material, lithium-metal, and lithium metal alloys.

28. The battery of claim 22, wherein the anode, the separator, the cathode are each one of an electrode-CSE laminate, current collector-CSE laminate, or CSE-based MIEC electrode.

29. The battery of claim 22, wherein the separator is a porous polyolefin separator that has been coated and/or infused with a CSE or composed of a freestanding CSE film.

30. The battery of claim 22, wherein the coating of infusion of CSE into and/or onto a cathode and/or anode to generate a discrete CSE may or may not produce a discrete CSE separator phase on the surface of the cathode and/or anode.

31. The battery of claim 22, wherein the current collector is coated with or infused with the CSE.

32. The battery of claim 22, wherein the current collector has a lithiophilic coating, including but not limited to metallic lithium.

33. The battery of claim 22, wherein the current collector is coated with a MIEC slurry to produce an electrode/CSE hybrid wherein the CSE serves the function of a binder phase and a Li ion-conducting phase and optionally serves the additional function of a discrete CSE separator phase on the surface of the MIEC.
